(19) United States
(12) Patent Application Publication
(10) Pub. No.: US 2019/0314849 A1
(43) Pub. Date: Oct. 17, 2019

(54) Passive Filter for Aerosol Printing

(71) Applicant: Government of the United States as represented by the Secretary of the Air Force, Wright-Patterson AFB, OH (US)

(72) Inventors: Michael F. Durstock, West Chester, OH (US); James R. Deneault, Kettering, OH (US)

(73) Assignee: Government of the United States as represented by the Secretary of the Air Force, Wright-Patterson AFB, OH (US)

(21) Appl. No.: 16/285,338

(22) Filed: Feb. 26, 2019

Related U.S. Application Data
(60) Provisional application No. 62/656,178, filed on Apr. 11, 2018.

(51) Int. Cl. B05B 15/40; B05B 1/34

(52) U.S. Cl. CPC B05B 15/40; B05B 1/34

(57) ABSTRACT

A passive filter for an aerosol printing system. The passive filter includes a housing having a fluid inlet port at a first end and a fluid outlet port at a second end, the fluid inlet and outlet ports being coaxial. A chamber is disposed within the housing and has a ceiling, a base, at least one wall between the ceiling and the base, a chamber entrance in the ceiling, and a chamber exit. The chamber entrance and exit being coaxial to the fluid inlet and outlet ports. The chamber exit is disposed within chamber between the chamber entrance and the base and defining a circumferential trough about the chamber exit.

Pursuant to 37 C.F.R. § 1.78(a)(4), this application claims the benefit of and priority to prior filed co-pending Provisional Application Ser. No. 62/656,178, filed Apr. 11, 2018, the disclosure of which is incorporated herein by reference in its entirety.

### GOVERNMENT INTEREST

The invention described herein may be manufactured and used by or for the Government of the United States for all governmental purposes without the payment of any royalty.

### FIELD OF THE INVENTION

The present invention relates generally to aerosol printing and, more particularly, to filters for aerosol printing systems.

### BACKGROUND OF THE INVENTION

Confluent aerosol printing is a system for material deposition that utilizes aerodynamic focusing to deposit a collimated stream of atomized ink droplets entrained in a gas stream onto particular substrates. While confluent aerosol printing technology is considered to be in its infancy, it is believed that the technology can lead to many potential commercial applications, such as the printing of novel small electronics (for example, interconnects) and electronic components (for example, resistors, capacitors, thin film transistors, etc.).

Referring to FIG. 1, a conventional confluent aerosol printing system 20 is having an atomizing chamber 22 and a deposition module 24 is shown. As illustrated, a desired ink 26 is placed into the atomizing chamber 22, which is fluidically coupled to an inert gas supply 28 via a gas inlet 30. An aerosol of atomized ink droplets 32 is created in the chamber 22 via pneumatic or ultrasonic means (not shown) and is directed to the deposition module 24 by the inert gas flowing into the chamber 22. The atomized ink droplets 32 may range in diameter from hundreds of nanometers to single-digit micrometers. For purposes of the illustration, the atomized ink droplets 32 created within the atomizing chamber 22 are hereafter referred to as an “aerosol” 34 with particular ink droplets 32 within the aerosol being referred to as “aerosol droplets” 32.

After the aerosol 34 is formed in the atomizing chamber 22, the aerosol 34 is directed through an exit 36 of the atomizing chamber 22 to the deposition module 24. The deposition module 24 generally includes flexible tubing 38 and the print nozzle assembly 40. The flexible tubing 38 directs the aerosol 34 from the atomizing chamber exit 36 to the print nozzle assembly 40. The print nozzle assembly 40 is intended to focus and collimate the aerosol 34 into a tight stream of droplets 42 using an aerodynamic lens 44. The aerodynamic lens 44 includes a centrally disposed ink channel 46 and a concentric and converging sheath gas channel 48. In operation, sheath gas (indicated by arrows 50 pointing towards the sheath gas channels 48) from a sheath gas supply 52 and aerosol 34 converge within the print nozzle assembly 44 to focus and direct the aerosol 34 into the tight stream of droplets 42 that exits a nozzle 54 toward a substrate (not shown) positioned at a distance away from the nozzle 54.

As noted above, the aerosol 34 produced in the atomizing chamber 22 and delivered to deposition module 24 is comprised of droplets 32 having a relatively wide range of dimensions (i.e., the aerosol 34 is considered to be a “polydisperse population” of droplets 32). It has been found that the ability of the deposition module 24, and particularly the print nozzle assembly 40 of deposition module 24, to focus and collimate the aerosol 34 into the tight stream of droplets 42 is limited by (1) the relatively higher inertia of the larger aerosol droplets 32 within the polydisperse population; and (2) the relatively higher diffusivity of the smaller aerosol droplets 32 within the polydisperse population. Even when good focusing is achieved, a minimum deposited feature size on the substrate is limited by the largest aerosol droplets 32 of the tight stream of droplets 42. For example, a 1 μm droplet in the polydisperse population may produce a 10 μm diameter spot on the substrate—of course this is dependent upon additional factors, such as wicking, contact angle, etc.

Additionally, as the aerosol 32 travels from the atomizing chamber 22 to the print nozzle assembly 40, a portion of the aerosol 32 may condense and deposit onto an inner surface of the flexible tubing 38, the atomizing chamber exit 36, and any other structures along the aerosol flow path between the atomizing chamber 22 and the print nozzle assembly 40 (illustrated as a consolidated drop 56 within the tubing 38. Sufficient accumulation of ink along these inner surfaces may result in the formation of larger drops that flow along the surfaces to the print nozzle assembly 40. Formation of these large drops may induce clogging, partial or complete, within the print nozzle assembly 40 if permitted to enter the small diameter (e.g., less than 500 μm) nozzle 54. In most cases, this clogging phenomenon is the limiting factor that determines system runtime and throughput as clogs typically result in ruined samples and require that the deposition module 24 or components thereof (such as the print nozzle assembly 40) be disassembled and cleaned or replaced.

In view of the above and other considerations, there is a need for an improved confluent aerosol printing system that reduces or eliminates the difficulties associated with a polydisperse population of aerosol droplets within an aerosol stream. There is also a need for a confluent aerosol printing system that can effectively handle or avoid troublesome ink accumulation within components of the deposition module of an aerosol printing system.

### SUMMARY OF THE INVENTION

The present invention overcomes the foregoing problems and other shortcomings, drawbacks, and challenges of conventional aerosol printing system resolution. While the invention will be described in connection with certain embodiments, it will be understood that the invention is not limited to these embodiments. To the contrary, this invention includes all alternatives, modifications, and equivalents as may be included within the spirit and scope of the present invention.

According to an embodiment of the present invention, a passive filter for an aerosol printing system includes a housing having a fluid inlet port at a first end and a fluid outlet port at a second end, the fluid inlet and outlet ports being coaxial. A chamber is disposed within the housing and has a ceiling, a base, at least one wall between the ceiling and the base, a chamber entrance in the ceiling, and a chamber exit. The chamber entrance and exit being coaxial to the fluid inlet and outlet ports. The chamber exit is disposed within chamber between the chamber entrance and the base and defining a circumferential trough about the chamber exit.

Other embodiments of the present invention include a passive filter for an aerosol system that includes a housing having a fluid inlet port at a first end and a fluid outlet port at a second end, the fluid inlet and outlet ports being coaxial. The housing includes first and second chamber. Each of the first and second chambers includes a respective ceiling, a base, at least one wall between the ceiling and the base, a chamber entrance in the ceiling, and a chamber exit. The chamber entrance and exit are coaxial to the fluid inlet and outlet ports, wherein the chamber exit is disposed within chamber between the chamber entrance and the base and defining a circumferential trough about the chamber exit.

Still other embodiments of the present invention include a passive filter printhead for an aerosol print system. The passive filter printhead has a housing having a fluid inlet port at a first end and an opposing second end, the fluid inlet port configured to receive an aerosol ink. A print nozzle configured to eject the aerosol ink is at the opposing second end of the housing, the print nozzle being configured to eject the aerosol ink. The fluid inlet of the housing and the print nozzle are coaxial. Between the fluid inlet port and the print nozzle is a passive filter that includes a chamber that is disposed within the housing. The chamber has a ceiling, a base, at least one wall between the ceiling and the base, a chamber entrance in the ceiling, and a chamber exit. The chamber entrance and exit being coaxial to the fluid inlet and outlet ports. The chamber exit is disposed within chamber between the chamber entrance and the base and defining a circumferential trough about the chamber exit. Expansion of the aerosol ink entering the chamber from the chamber entrance filters the aerosol ink.

According to one embodiment of the present invention, the above and other needs are met by a passive filter for a confluent aerosol printing system. The passive filter includes a housing including an inlet port configured to receive an aerosol from the aerosol printing system and an outlet port configured to transmit a filtered aerosol. The passive filter further includes a chamber disposed within the housing between the inlet port and the outlet port having a chamber entrance in a chamber ceiling that is in fluidic communication with the inlet port and having an entrance diameter; a chamber base; at least one wall extending between the chamber ceiling and the chamber base; a chamber exit within the chamber and that is in fluidic communication with the outlet port. The chamber exit is coaxial with the chamber entrance and may have an exit diameter that is equal to or less than the entrance diameter. A trough is formed between the chamber exit and the at least one wall. In operation, aerosol received through the inlet port of the housing is filtered as the aerosol flows through the chamber via expansion of the aerosol as the aerosol enters the chamber. Aberrant aerosol flows into the trough while filtered aerosol flows through the chamber exit to the outlet port of the housing.

According to certain embodiments, the inlet port, chamber entrance, chamber exit, and outlet port are coaxially aligned along an aerosol flow path.

According to certain embodiments, an angular wall extends between the chamber exit and the at least one wall to form the trough.

According to certain embodiments, the filter chamber includes an angular entrance wall or an antechamber at the ceiling.

According to certain embodiments, the housing includes a first housing portion including the inlet port and the chamber entrance and a second housing portion including the outlet port and the chamber exit. The first housing portion and the second housing portion may be removably coupled together for forming the filter chamber.

According to another embodiment of the disclosure, a passive filter for an aerosol printing system includes a housing having an inlet port configured to receive an aerosol from the aerosol printing system and an outlet port configured to transmit a filtered aerosol. The passive filter further includes a filter chamber disposed within the housing between the inlet port and the outlet port. The filter chamber includes a chamber entrance at a chamber ceiling, the chamber entrance being in fluidic communication with the inlet port and having an entrance diameter; a chamber base; and at least one wall extending between the chamber ceiling and the chamber base. A chamber exit is disposed in the filter chamber between the chamber entrance and the chamber base and has an exit diameter. The chamber exit is in fluidic communication and coaxial with the chamber entrance and the outlet port. The exit diameter is equal to or less than the entrance diameter. An angular wall may extend between the chamber exit and the at least one wall to form the trough. In operation, aerosol received through the inlet port of the housing is filtered as the aerosol flows through the chamber such that aberrant aerosol collects within the trough and filtered aerosol passes through the chamber exit.

According to certain embodiments, the inlet port, chamber entrance, chamber exit, and outlet port are each coaxial along the aerosol flow path.

According to certain embodiments, the filter chamber further includes an angular wall that extends away from the chamber entrance at the chamber ceiling towards one or more sidewalls of the filter chamber. According to some embodiments, the angular entrance wall is rounded.

According to certain embodiments, the housing further includes a chamber exit lumen for fluidly connecting the chamber exit to the outlet port.

According to certain embodiments, the housing includes a first housing portion including the inlet port and the chamber entrance and a second housing portion including the outlet port and the chamber exit. The first housing portion and the second housing portion may be removably coupled together for forming the filter chamber.

Yet other embodiments of the present invention are directed to a method of filtering an aerosol of an aerosol printing system by directing the aerosol into a filter chamber through a chamber inlet, the filter chamber comprising a ceiling having the chamber entrance, a base, at least one wall between the ceiling and the base, and a chamber exit disposed within chamber between the chamber entrance and the base and defining a circumferential trough about the chamber outlet, wherein the chamber entrance and exit are coaxial. The aerosol expands within the filter chamber. Aberrant aerosol is captured within the trough while filtered aerosol passes through the chamber exit.

According to yet another embodiment of the disclosure, a method of filtering an aerosol in an aerosol printing system having an atomizing chamber in fluid communication with a print nozzle includes: providing a passive filter along an aerosol flow path between the atomizing chamber and the print nozzle, the passive filter including a filter chamber having a chamber entrance at a chamber ceiling and having an entrance diameter; a chamber base; a chamber exit within the chamber that is coaxial with the chamber entrance and having an exit diameter that is equal to or less than the entrance diameter; at least one wall extending between the chamber ceiling and the chamber base; and a trough between the at least one wall and the chamber exit. Aerosol flows from the atomizing chamber along the aerosol flow path through the filter chamber of the passive filter to provide a filtered aerosol to the print nozzle. The flowing of aerosol includes receiving the aerosol through the chamber entrance, providing divergence of the aerosol flow as it enters into and traverses through the filter chamber, filtering the aerosol as the aerosol flows from the chamber entrance through the chamber exit, and collecting filtered aerosol droplets from the aerosol in the trough as the filtered aerosol flows through the chamber exit.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

Other embodiments of the present invention will become apparent by reference to the detailed description in conjunction with the figures, wherein elements are not to scale so as to more clearly show the details, wherein like reference numbers indicate like elements throughout the several views.

FIG. 1 is a side elevational view of an aerosol printing system according to the prior art, shown in cross-section.

FIG. 2 is a side elevational view, in cross-section, of a passive filter according to one exemplary embodiment of the present invention.

FIG. 3 is a perspective view of the passive filter of FIG. 2.

FIG. 4 is a cross-sectional view of the passive filter taken along the line 4-4 in FIG. 3.

FIG. 5 is a side elevational view, in cross-section, of an aerosol printing system with the passive filter of FIG. 2.

FIGS. 6-8 are side elevational views, each in cross-section, of passive filters according to various embodiments of the present invention.

FIGS. 9-11 are side elevational views, each in cross-section, of passive filters according to other embodiments of the present invention.

FIG. 12 is a side elevational view, in cross-section, of a passive filter according to one exemplary embodiment of the present invention.

FIGS. 13 and 14 are side elevational views, in cross-section, of passive filters according to embodiments of the present invention.

FIG. 15 is a side elevational view, in cross-section, of a passive filter having a filter chamber with a rounded angular entrance wall according to one exemplary embodiment of the present invention.

FIG. 16 is a side elevational view, in cross-section, of a combination passive filter and print nozzle, according to an embodiment of the present invention.

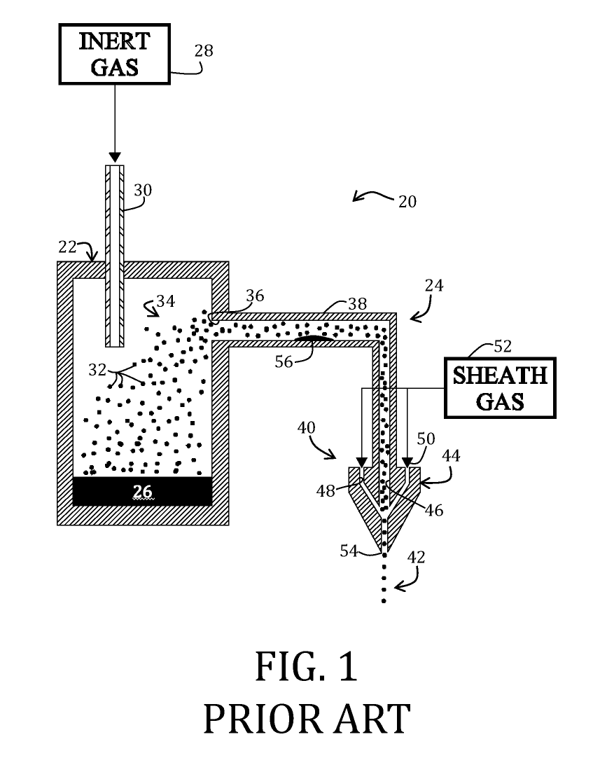

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

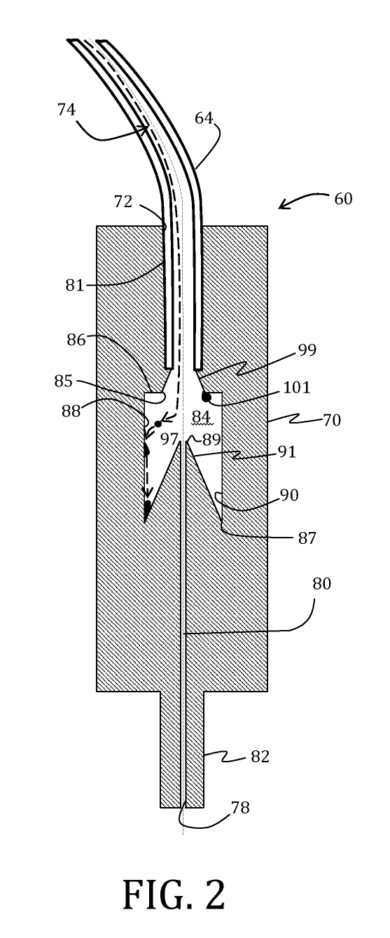

Referring now to FIGS. 2-5, a passive filter 60 for use with a confluent aerosol printing system 62 according to an embodiment of the present invention is shown. As shown, the passive filter 60 is configured to be placed along an aerosol line 64, proximate to the print nozzle assembly 66 but upstream of the introduction of the sheath gas channel 68. While embodiments of the present invention may be adapted to be incorporated into nearly any aerosol printing system, one exemplary commercial system is the OPTOMEC UP-300. While the embodiments specifically shown and described herein introduce the passive filter 60 as an additional component that connects to the aerosol line 64 using an adapter/connector to the print nozzle assembly 66, the skilled artisan having the benefit of the disclosure made herein would readily understand that the passive filter 60 may alternatively be incorporated into the nozzle assembly, itself.

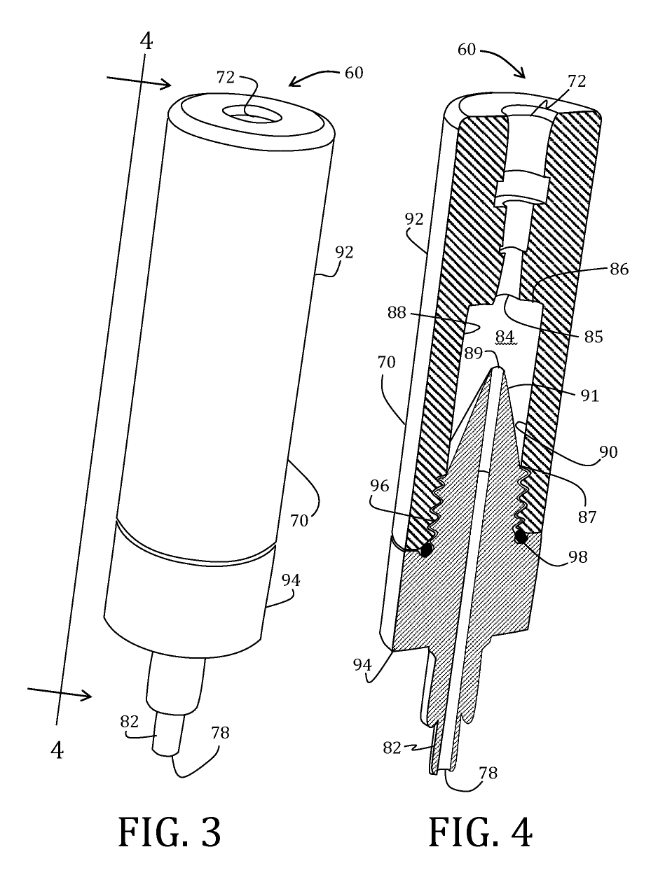

Referring still to FIGS. 2-5, the passive filter 60 generally includes a housing 70 having an inlet port 72 for receiving the aerosol 74 from the aerosol chamber 76 and an outlet port 78 for transmitting a filtered aerosol 80 from the housing 70 to the nozzle 66. According to this embodiment, the inlet port 72 includes a compression fitting 81 (illustrated only in the enlarged, cross-sectional view in FIG. 2) for connecting the filter 60 to the aerosol line 64. The outlet port 78 may include a friction fitting 82 (FIGS. 3 and 4) that is configured to receive another piece of tubing or the print nozzle assembly 66. It would be understood by those of ordinary skill in the art having the benefit of the disclosure made herein that other types or styles of connections may be used, in the alternative, to fluidically couple the passive filter 60 to other components of the aerosol printing system 62.

Referring specifically to FIGS. 2 and 4, the passive filter 60 includes a filter chamber 84 within the housing 70 between, and in fluid communication with, the inlet port 72 and the outlet port 78. The filter chamber 84 may be configured to filter the aerosol 74 as the aerosol 74 flows through the housing 70 from the inlet port 72 to the outlet port 78. The filter chamber 84 includes a chamber entrance 85 at a chamber ceiling 86 and having an entrance diameter, a chamber base 87, and at least one chamber wall 88 extending between the chamber ceiling 86 and the chamber base 87.

A chamber exit 89, having an exit diameter that is less than or equal to the entrance diameter—such as in the illustrative embodiment wherein the exit diameter is less than the entrance diameter—is disposed within the chamber between the chamber ceiling 86 and the chamber base 87 so as to provide a trough 90 about the chamber exit 89 and at the chamber base 87. As illustrated, the trough 90 may be formed by providing an angular, interior wall 91 that extends downstream from the chamber exit 89. Thus, as the aerosol 16 is constricted by the chamber exit 89, filtered aerosol droplets flow down the one or more angular exit walls 91 towards the bottom of the one or more troughs 90. An angle of the annular wall 91 may vary with respect to vertical (i.e., the linear flow path), with typical angles ranging from about 55° to about 70°.

The chamber entrance 85 and the chamber exit 89 are generally coaxial such that an approximately linear flow path extends through the housing 70, from the inlet port 72 to the outlet port 78. According to the illustrated embodiment, the inlet port 72, the outlet port 78, the chamber entrance 85, the chamber exit 89, and the filter chamber 84 are all coaxial and provide a coaxial lumen through the housing 70.

As specifically illustrated in FIG. 4, the trough 90 may be formed by the joining together of an upstream housing portion 92 with a downstream housing portion 94, wherein the downstream housing portion 94 includes the chamber exit 89 and the annular wall 91. Joining of the upstream and downstream housing portions 92, 94 may be accomplished in known ways—the illustrated embodiment includes matching screw threads 96 with an O-ring seal 98. However, as other mechanical mechanisms exist for joining the two portions 92, 94, the invention should not be so limited to the illustrated example. The particular embodiment of FIG. 4 with a multiple portion construction may be beneficial in that it facilitates maintenance and cleaning of the passive filter 60. That is, the upstream and downstream housing portions 92, 94 may be disassembled and the housing 70 easily cleaned for reuse.

Referring specifically to FIG. 2, it can be observed that a diameter of the filter chamber 84 is greater than the entrance diameter of the chamber entrance 85 such that aerosol 74 entering the filter chamber 84 may expand (illustrated as a dashed-lined arrow 97). While not wishing to be bound by any particular scientific theory or principle, droplets within the aerosol 74 diverging from a linear flow path once within the filter chamber 84 may be those droplets having greater momentum and/or higher diffusivity. Said another way, the diverging portion of the aerosol 97 is generally comprised of very large droplets, very small droplets, or both. The diverging aerosol 97 are, by consequence of the expansion, directed to a wall of the filter chamber 84 and flow into the trough 90. The smaller, exit diameter of the chamber exit 89 facilitates the removal of the diverging (or aberrant) portion of the aerosol 97 by restricting the filtered aerosol 80 to only those droplets having a largely linear flow path. The filter chamber 84, therefore, constricts (i.e., make narrower) a diameter of the filtered aerosol 80 as compared to the aerosol 74 entering the passive filter 60. Constricting the aerosol 80 in this way reduces the polydisperity and may greatly improve print quality and resolution.

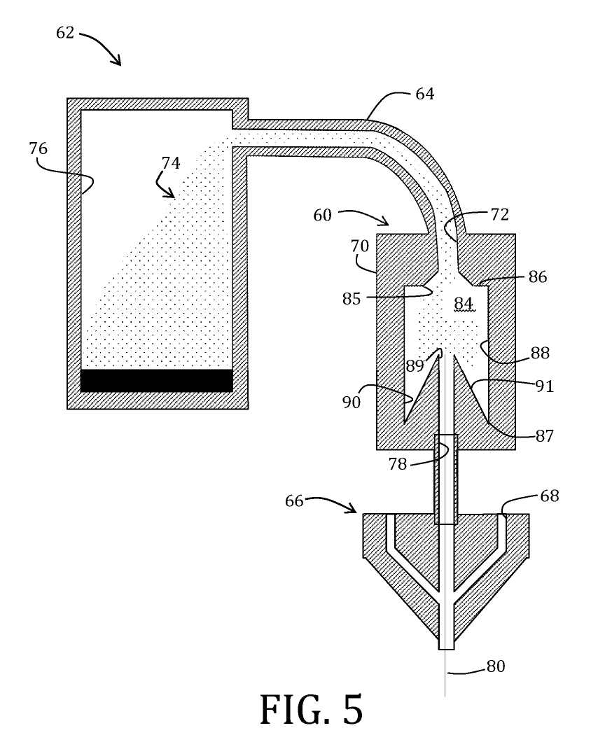

The diverging aerosol 97 is collected and may coalesce within the trough 90 while the filtered aerosol 80 moves through the chamber exit 89 and outlet port 78 to the print nozzle assembly 66 (FIG. 5). Use of the passive filter 60 with a conventional print nozzle assembly 66 (FIG. 5) may increase the efficacy of an otherwise conventional aerosol printing system 62 (FIG. 5) because the printed aerosol is more focused and collimated, which may provide greater print resolution (smaller achievable features) with reduced overspray by print nozzle assembly 66 (FIG. 5).

Another aspect specific to the embodiment of FIG. 2 is a flared wall 99 at the chamber entrance 85 of the chamber ceiling 86, upstream of the filter chamber 84. That is, the flared wall 99 may be at least partially disposed between the inlet port 72 and the chamber entrance 85 and may resist or prevent an accumulation of ink at the chamber entrance 85. For example, droplet 101, by way of the flared wall 99, moves from the chamber entrance 85 toward the trough 90 along the at least one wall 88 and, more particularly, away from the chamber exit 89. It will be noted by those of ordinary skill in the art having the benefit of the disclosure made herein that the shape and angle of the at least one wall 88 need not be limited to the illustrative embodiment of FIG. 2; rather the shape and angle may vary according to preference and aerosol flow optimization.

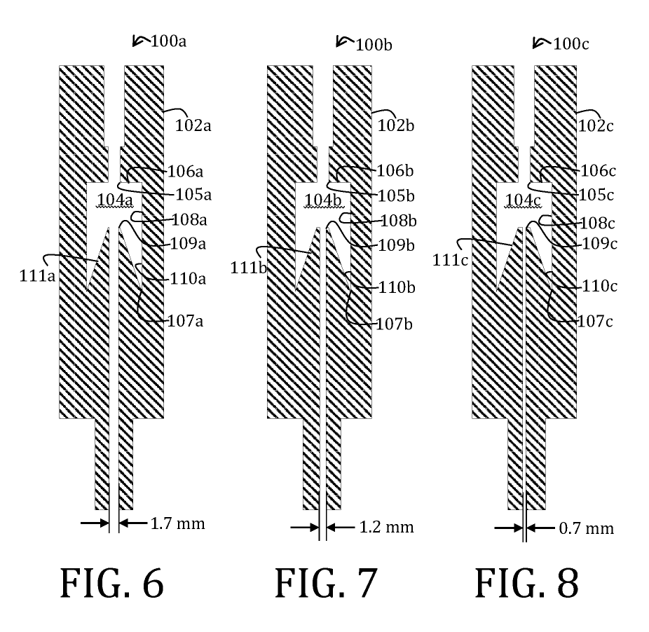

Referring now to FIGS. 6-8, various embodiments of passive filters 100a, 100b, 100c are shown and each generally, and respectively, includes a housing 102a, 102b, 102c with a filter chamber 104a, 104b, 104c therein. Each filter chamber 104a, 104b, 104c includes a chamber entrance 105a, 105b, 105c in a chamber ceiling 106a, 106b, 106c; a chamber base 107a, 107b, 107c; at least one wall 108a, 108b, 108c extending between the ceiling 106a, 106b 106c and the base 107a, 107b 107c; a chamber exit 109a, 109b, 109c that is disposed within the filter chamber 104a, 104b, 104c between the ceiling 106a, 106b, 106c and the base 107a, 107b, 107c; and a trough 110a, 110b, 110c between the outlet 109a, 109b, 109c and the at least one wall 108a, 108b, 108c. As noted above, an angular wall 111a, 111b, 111c may extend between the chamber exit 109a, 109b, 109c and the at least one wall 108a, 108b, 108c to form the trough 110a, 110b, 110c.

As shown, the chamber entrance 105a, 105, 105c, the chamber exit 109a, 109b, 109c, and the filter chamber 104a, 104b, 104c may be coaxial.

The particular embodiments of FIGS. 6-8 vary by a diameter of each chamber exit 109a, 109b, 109c, which may range from about 0.1 mm to about 5 mm; although, the illustrated embodiments demonstrate a range from 0.7 mm to 1.7 mm. Varying the diameter of the chamber exit 109a, 109b, 109c may be advantageous so as to optimize the filtered aerosol 80 (FIG. 5). An optimal diameter may depend on various factors, such as the desired application, the ink composition, composition/properties of the substrate to be printed upon, a distance between the aerosol chamber 76 (FIG. 5) and the print nozzle 66 (FIG. 5), a diameter of the print nozzle 66 (FIG. 5), a velocity of the aerosol, and so forth.

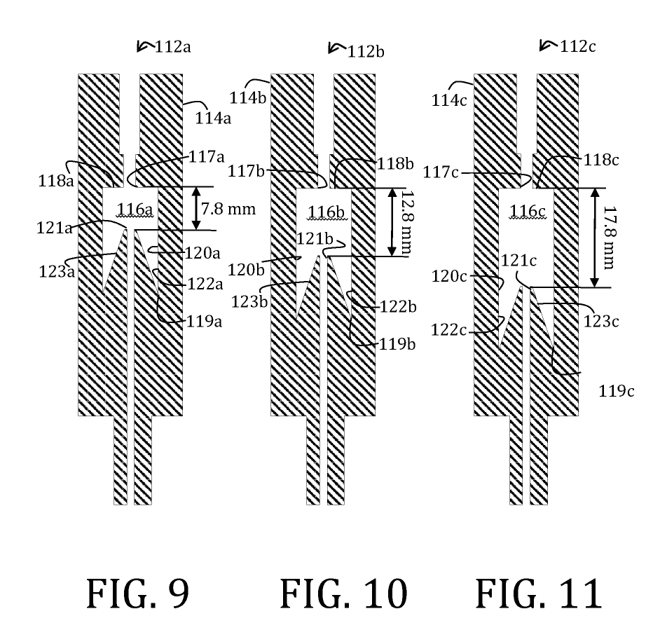

Referring now to FIGS. 9-11, various embodiments of passive filters 112a, 112b, 112c are shown and each generally, and respectively, include a housing 114a, 114b, 114c with filter chamber 116a, 116b, 116c therein. Each filter chamber 116a, 116b, 116c includes a chamber entrance 117a, 117b, 117c in a chamber ceiling 118a, 118b, 118c; a chamber base 119a, 119b, 119c; at least one wall 120a, 120b, 120c extending between the ceiling 116a, 116b, 116c and the base 119a, 119b, 119c; a chamber exit 121a, 121b, 121c that is disposed within the filter chamber 116a, 116b, 116c; and a trough 122a, 122b, 122c between the chamber exit 121a, 121b, 121c and the at least one wall 120a, 120b, 120c. An angular wall 123a, 123b, 123b may extend between the chamber exit 121a, 121b, 121c and the at least one wall 120a, 120b, 120c to form the trough 122a, 122b, 122c.

As shown, the chamber entrance 117a, 117, 117c, the chamber exit 121a, 121b, 121c, and the filter chamber 116a, 116b, 116c may be coaxial.

The particular embodiments of FIGS. 9-11 vary by a distance between the chamber entrance 117a, 117b, 117c and the chamber exit 121a, 121b, 121c of the filter chamber 116a, 116b, 116c, which may range from about 2 mm to about 50 mm; although, the illustrated embodiments range from 7.8 mm to 17.8 mm. Optimizing the distance between the entrance 117a, 117b, 117c and the exit 121a, 121b, 121c may depend on factors that are similar to those described above with respect to FIGS. 6-8.

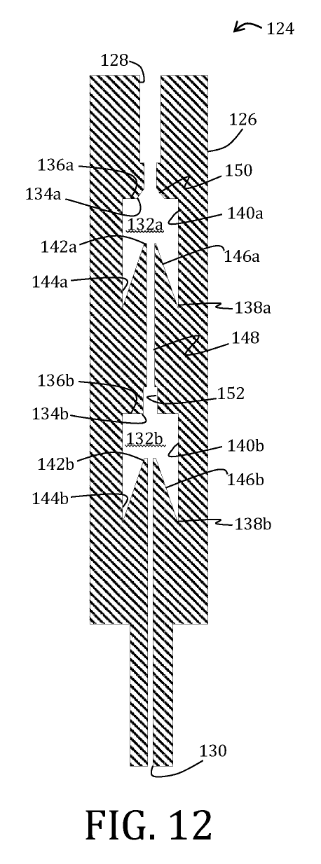

In FIG. 12 a passive filter 124 according to another embodiment of the present invention is shown and includes a housing 126 having an inlet 128, an outlet 130, a first filter chamber 132a between the inlet 128 and the outlet 130, and a second filter chamber 132b between the first filter chamber 132a and the outlet 130. Each of the first and second chambers 132a, 132b includes a respective chamber entrance 134a, 134b in a chamber ceiling 136a, 136b; a chamber base 138a, 138b; at least one wall 140a, 140b extending between the ceiling 136a, 136b and the base 138a, 138b; an chamber exit 142a, 142b that is disposed within the filter chamber 132a, 132b between the ceiling 136a, 136b and the base 138a, 138b; and a trough 144a, 144b between the chamber exit 142a, 142b and the at least one wall 140a, 140b. An angular wall 146a, 146b may extend between the chamber exit 142a, 142b and the at least one wall 140a, 140b to form the trough 144a, 144b.

As shown, the inlet 128, outlet 130, chamber entrances 134a, 134b, the chamber exits 142a, 142b, and the filter chambers 132a, 132 may be coaxial.

A pathway 148 fluidically couples the first chamber exit 142a to the second chamber entrance 134b. While the first and second chambers 132a, 132b have similar shape and structures, one of ordinary skill in the art having the benefit of this disclosure would understand this to be merely exemplary and not limiting. In fact, some differences between the illustrated first and second chambers 132a, 132b may be noted. For example, the first chamber entrance 134a includes a flared wall 150, which is similar to the passive filter embodiment illustrated in FIG. 2. The second chamber entrance 134b includes an antechamber 152 rather than a flared wall 150, wherein the antechamber 152 is an enlarge diameter chamber upstream of the second chamber entrance 134b. Another distinction between the first and second chambers 132a, 132b, as illustrated in FIG. 12, is a diameter of the first chamber exit 142a that is larger than a diameter of the second chamber exit 142b.

According to this embodiment, an aerosol (not illustrated in FIG. 12) may be still further refined (constricted) by twice filtering out the peripherally, diverging aerosol 97 (FIG. 2).

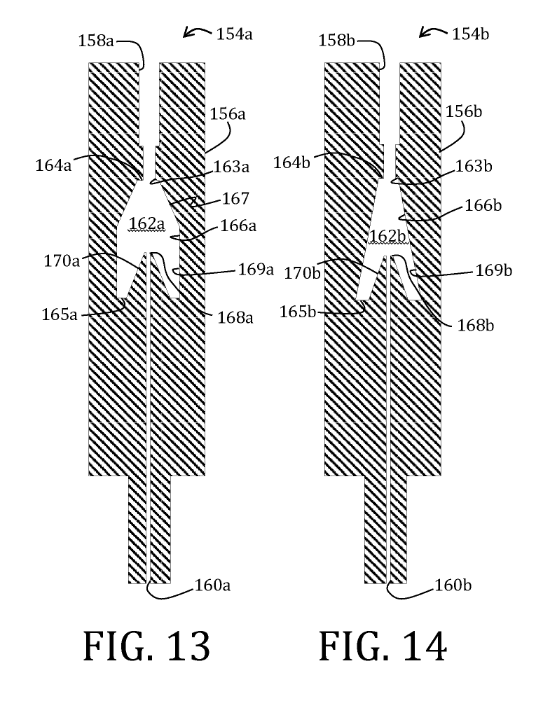

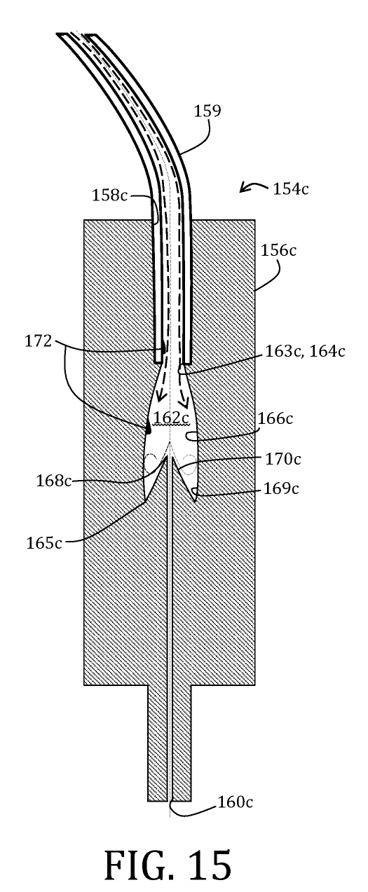

FIGS. 13-15 illustrate passive filters 154a, 154b, 154c according to additional embodiments of the present invention. Each passive filter 154a, 154b, 154c generally includes a housing 156a, 156b, 156c with an inlet 158a, 158b, 158c (tubing 159 included in the illustration of FIG. 15), an outlet 160a, 160b, 160c, and a filter chamber 162a, 162b, 162c therebetween. Each filter chamber 162a, 162b, 162c includes a chamber entrance 163a, 163b, 163c in a chamber ceiling 164a, 164b, 164c; a chamber base 165a, 165b, 165c; at least one wall 166a, 166b, 166c extending between the ceiling 164a, 164b, 164c and the base 165a, 165b, 165c (noting FIG. 13 includes a second wall 167 with the at least one wall 166a); a chamber exit 168a, 168b, 168c that is disposed within the filter chamber 162a, 162b, 162c; and a trough 169a, 169b, 169c between the chamber exit 168a, 168b, 168c and the at least one wall 166a, 166b, 166c (with the second wall 167 of FIG. 13). An angular wall 170a, 170b, 170b may extend between the chamber exit 168a, 168b, 168c and the at least one wall 166a, 166b, 166c to form the trough 169a, 169b, 169c.

As shown, the respective inlets 158a, 158b, 158c, chamber entrances 163a, 163b, 163c, chamber exits 168a, 168b, 168c, and the filter chamber 162a, 162b, 162c may be coaxial.

The embodiments of FIGS. 13-15 differ in structure with respect to the at least one of the walls 166a, 166b, 166c. That is, according to the embodiment of FIG. 13, a second wall 167 extends between the at least one wall 166a and the chamber ceiling 164a. The second wall 167 may be operable in a manner similar to the flared wall 170 (FIG. 2) by reducing a likelihood of aerosol accumulation 172 at the chamber entrance 163a. According to the embodiment of FIG. 14, the at least one wall 166b is angled from the chamber entrance 163b to the trough 169b to facilitate the flow of diverging ink 172 into the trough 169b. According to the embodiment of FIG. 15, the at least one wall 166c is a flowing extension from the chamber entrance 163c and, therefore, does not include an abrupt distinction between the chamber entrance 163c and the filter chamber 162c by minimizing the chamber ceiling 164c and further reducing a likelihood of aerosol condensation 172 at the chamber entrance 163c.

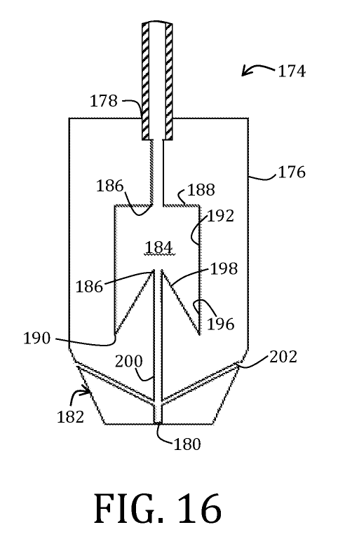

Finally, with reference to FIG. 16, another embodiment of the present invention is shown and includes a composite print nozzle and filter 174. The composite print nozzle and filter are incorporated into a single housing 176, which, although not specifically illustrated in FIG. 16, may be comprised of multiple portions similar to that of FIGS. 3 and 4. The housing 176 has an inlet 178, an outlet 180 (at a print nozzle portion 182), and a filter chamber 184 positioned therebetween.

The filter chamber 182 includes a chamber entrance 184 having an entrance diameter at a chamber ceiling 188; a chamber base 190; at least one wall 192 extending between the ceiling 188 and the base 190; a chamber exit 194 that is disposed within the filter chamber 184 between the ceiling 188 and the base 190; and a trough 196 between the outlet 194 and the at least one wall 192. As noted above, an angular wall 198 may extend between the chamber exit 194 and the at least one wall 192 to form the trough 196.

As shown, the inlet 178, chamber entrance 186, the chamber exit 194, the outlet 180, and the filter chamber 184 may be coaxial.

Filtered aerosol (not shown in FIG. 16) passes through the chamber exit 194, along an aerosol passage 200 to the print nozzle portion 182. As is typical to conventional aerosol print nozzles, a sheath gas channel 202 permits a sheath gas to enter the print nozzle and thus focus the filtered aerosol as it emerges from the outlet 180.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

1. A passive filter for a confluent aerosol printing system, the passive filter comprising:
a housing having a fluid inlet port at a first end and a fluid outlet port at a second end, the fluid inlet and outlet ports being coaxial;
a chamber disposed within the housing and having a ceiling, a base, at least one wall between the ceiling and the base, a chamber entrance in the ceiling, and a chamber exit, the chamber entrance and exit being coaxial to the fluid inlet and outlet ports; and
wherein the chamber exit is disposed within chamber between the chamber entrance and the base and defining a circumferential trough about the chamber exit.

2. The passive filter of claim 1, wherein a diameter of the chamber exit is equal to or less than a diameter of the chamber entrance.

3. The passive filter of claim 1, wherein an angular wall extends between the chamber exit and the base of the chamber and the trough is formed between the angular wall and the at least one wall of the chamber.

4. The passive filter of claim 1, wherein a diameter of the chamber is greater than a diameter of the chamber entrance.

5. The passive filter of claim 4, wherein expansion of an aerosol entering the chamber from the chamber entrance filters the aerosol.

6. The passive filter of claim 1, wherein the fluid inlet port is configured to be operably coupled to an aerosol chamber.

7. The passive filter of claim 1, wherein the fluid outlet port is configured to be operably coupled to a print head.

8. The passive filter of claim 1, wherein the housing includes a first housing portion including the inlet port and the chamber entrance and a second housing portion including the outlet port and the chamber exit, the first housing portion and the second housing portion configured to be removably connected for forming the filter chamber.

9. A passive filter for a confluent aerosol printing system, the passive filter comprising:
a housing having a fluid inlet port at a first end and a fluid outlet port at a second end, the fluid inlet and outlet ports being coaxial;
a first chamber disposed within the housing and having a first ceiling, a first base, at least one wall between the first ceiling and the first base, a first chamber entrance in the first ceiling, and a first chamber exit, the first chamber entrance and exit being coaxial to the fluid inlet and outlet ports, wherein the first chamber exit is disposed within first chamber between the first chamber entrance and the first base and defining a first circumferential trough about the first chamber exit; and
a second chamber disposed within the housing between the first chamber and the fluid outlet port, the second chamber having a second ceiling, a second base, at least one wall between the second ceiling and the second base, a second chamber entrance in the second ceiling, and a second chamber exit, the second chamber entrance and exit being coaxial to the fluid inlet and outlet ports, wherein the second chamber exit is disposed within second chamber between the second chamber entrance and the second base and defining a second circumferential trough about the second chamber exit.

10. The passive filter of claim 9, wherein a diameter of the first chamber exit is equal to or less than a diameter of the first chamber entrance.

11. The passive filter of claim 9, wherein a diameter of the second chamber exit is equal to or less than a diameter of the second chamber entrance.

12. The passive filter of claim 9, wherein an angular wall extends between the first chamber exit and the first base of the first chamber and the first trough is formed between the angular wall and the at least one wall of the first chamber.

13. The passive filter of claim 9, wherein an angular wall extends between the second chamber exit and the second base of the second chamber and the second trough is formed between the angular wall and the at least one wall of the second chamber.

14. The passive filter of claim 9, wherein a diameter of the first chamber is greater than a diameter of the first chamber entrance.

15. The passive filter of claim 9, wherein a diameter of the second chamber is greater than a diameter of the second chamber entrance.

16. The passive filter of claim 9, wherein expansion of an aerosol entering the first chamber from the first chamber entrance filters the aerosol.

17. The passive filter of claim 16, wherein expansion of the aerosol entering the second chamber from the second chamber entrance further filters the aerosol.

18. The passive filter of claim 9, wherein the fluid inlet port is configured to be operably coupled to an aerosol chamber.

19. The passive filter of claim 9, wherein the fluid outlet port is configured to be operably coupled to a print head.

20-31. (canceled)
